(19) United States
(12) Patent Application Publication
(10) Pub. No.: US 2013/0213308 A1
(43) Pub. Date: Aug. 22, 2013

(54) Pet Bowl For Keeping Water Fresh

(71) Applicant: James Donald Koskey, JR., Colorado Springs, CO (US)

(72) Inventor: James Donald Koskey, JR., Colorado Springs, CO (US)

(21) Appl. No.: 13/397,914

(22) Filed: Feb. 16, 2012

(51) Int. Cl. A01K 7/00

(52) U.S. Cl. 119/74

(57) ABSTRACT

A pet drinking bowl designed to keep water fresh has a first housing section containing a drinking bowl and a pump section. A second housing section covers the pump section. There is an inlet and an outlet between the bowl section and the pump section. A filter is adjacent to the inlet. A pump with an exit is connected to the outlet. The device may include a gravity feed water reservoir that has a conduit into the pump section. The first and second housing sections are made of dishwasher safe materials. The pet drinking bowl is a two cavity mold and the two housing sections snap fit together.

### RELATED APPLICATIONS

Not Applicable

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Pet bowls usually hold a fixed amount of water and this water overtime gets stale. There are systems for automatically refilling a pet bowl with water as the water is drunk or evaporates, but these systems do not keep the water fresh, just full. Other attempts to provide fresh water for pets include pet drinking fountains. These devices shoot water in the air or out of a spigot into a bowl and use a pump to re-circulate the water. Some of the systems continuously re-circulate the water and others are activated by the pet coming close to the water bowl. One problem with the fountain type systems is they tend to splash water onto the floor, which can be damaging on wood floors and make other floors dirty. Even the waterfall type of pet watering bowl is likely to splash. Another problem with these systems is that they tend to be noisy and some pets are frightened by the noise and the stream of water.

Another problem with these pet fountains is that they tend to have multiple parts and be very complex. As a result, they cannot be manufactured and shipped cheaply. Since the pet market tends to be very price sensitive this limits the usefulness of these earlier designs. In addition, the complexity makes it difficult to wash these devices, which allows algae and other things to start to grow in the mechanisms. This defeats the purpose of keeping the water fresh. Current products also only draw water from near the bottom of the bowl, thus allowing only submerged debris to be filtered. Floating debris cannot be filtered out.

Thus there exists a need for a pet water device that keeps the water fresh, is inexpensive to build, easy to wash, does not spill on the floor, and is q

### BRIEF SUMMARY OF INVENTION

A pet drinking bowl designed to keep water fresh that overcomes these and other problems has a first housing section containing a drinking bowl and a pump section. A second housing section covers the pump section. There is an inlet and an outlet between the bowl section and the pump section. A filter is adjacent to the inlet. A pump with an exit is connected to the outlet.

In one embodiment, the device has a gravity feed water reservoir that has a conduit into the pump section. The first and second housing sections are made of dishwasher safe materials. In one embodiment, the pet drinking bowl is a two cavity mold and the two housing sections snap fit together. In another embodiment, the filter and pump just fit into a holder in the housing. This makes the pet drink bowl inexpensive to manufacture, inexpensive to assemble and easy to wash. The gravity feed water reservoir is blow molded in one embodiment.

In one embodiment, the water outlet is along an edge of the bowl and the bowl has a circular shape. As a result, the water is pushed in a circular motion and creates a soft whirlpool that freshens the water. This design does not cause splashes and the soft action does not frighten pets.

### BRIEF DESCRIPTION OF THE SEVERAL VIEWS OF THE DRAWINGS

FIG. 1 is a top left perspective view of a pet whirlpool bowl in accordance with one embodiment of the invention;

FIG. 2 is a top left perspective view of a pet whirlpool bowl in accordance with one embodiment of the invention;

FIG. 3 is a top view of a first housing section of a pet whirlpool bowl with a pump and filter in accordance with one embodiment of the invention; and

FIG. 4 is a front view of a water inlet in accordance with one embodiment of the invention.

### DETAILED DESCRIPTION OF THE INVENTION

A pet drinking bowl designed to keep water fresh that overcomes these and other problems has a first housing section containing a drinking bowl and a pump section. A second housing section covers the pump section. There is an inlet and an outlet between the bowl section and the pump section. A filter is adjacent to the inlet. A pump with an exit is connected to the outlet.

In one embodiment, the device has a gravity feed water reservoir that has a conduit into the pump section. The first and second housing sections are made of dishwasher safe materials. In one embodiment, the pet drinking bowl is a two cavity mold and the two housing sections snap fit together. In another embodiment, the filter and pump just fit into a holder in the housing. This makes the pet drink bowl inexpensive to manufacture, inexpensive to assembly, and easy to wash. The gravity feed water reservoir is blow molded in one embodiment.

In one embodiment, the outlet is along an edge of the bowl and the bowl has a circular shape. As a result, the water is pushed in a circular motion and creates a soft whirlpool that freshens the water. This design does not cause splashes and the soft action does not frighten pets.

FIG. 1 is a top left perspective view of a pet whirlpool bowl 10 in accordance with one embodiment of the invention. The pet bowl 10 has a bowl 12 attached to a pump section 14. There is an outlet 16 that allows water to flow from the bowl 12 to the pump section 14. An inlet 18 allows water to flow from the pump section 14 into the bowl 12. Overall the pet bowl 10 is made of two housing sections, a base or first housing section 20 and a top or second housing section 22. The top section 22 fits over a pump and forms the pump section.

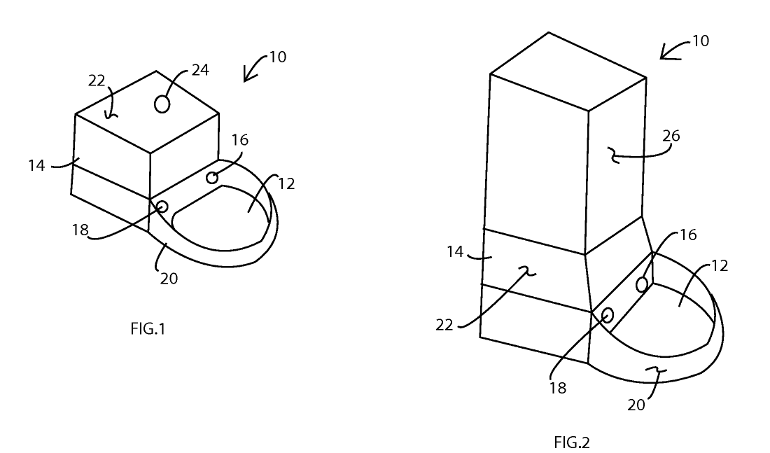

In one embodiment, the top section 22 has an opening or conduit 24 for a gravity feed water reservoir (see FIG. 2).

In one embodiment, the first housing section and the second housing section are formed in a two part mold.

FIG. 2 is a top left perspective view of a pet whirlpool bowl 10 in accordance with one embodiment of the invention. This embodiment of the pet whirlpool bowl 10 includes a gravity feed water reservoir 26. This reservoir 26 is in communication with the pump section 14 through a conduit 24. This reservoir 26 refills the water in the bowl 12 when a pet or evaporation reduces the level of the water. In one embodiment, the reservoir is blow molded and has a valve that prevents spills. The valve is actuated by a spike in base when the reservoir is placed in its operating position.

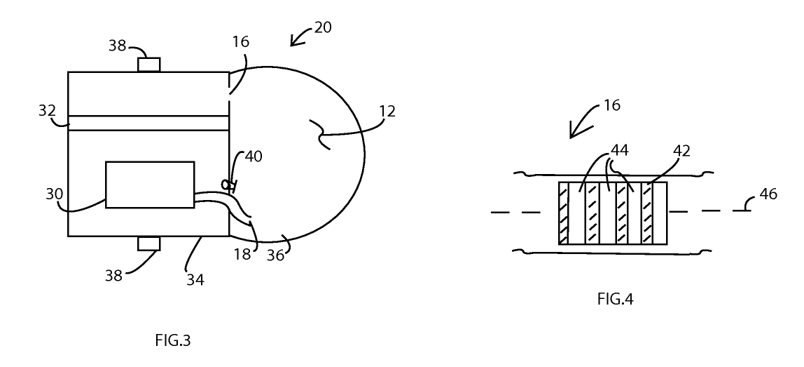

FIG. 3 is a top view of a first housing section 20 of a pet whirlpool bowl with a pump 30 and a filter 32 in accordance with one embodiment of the invention. The pump 30 may be a submersible pump. The outlet 34 of the pump 30 may be connected by a conduit to the edge 36 of the bowl 12. The bowl 12 is roughly circular and this creates a soft whirlpool effect. The filter 32 is placed between the pump 30 and the inlet 16. The filter 32 may be a carbon activated filter in one embodiment. The structure of the first housing section 20 may include mounts for holding the filter and pump in place. This simplifies the construction of the bowl.

In one embodiment, the first housing section 20 has slots 38 for snap fit to the top section 22. The water reservoir 26 may snap fit onto the top section 22 or may just have an interlocking slot and lip. In another embodiment, the water reservoir sits next to the pump section 14 instead of on top of the pump section 14. The simple connections between the base and top sections make it easy for the owner to break the bowl 10 apart and put the first and second housing sections in the dishwasher. The first and second housing section may be made of a dishwasher safe plastic. This makes sure that algae and other organisms do not build up in the whirlpool bowl and defeat the ability to keep the water fresh and healthy for the pets.

Note that the pump 30 is an electric pump and may be powered by an electrical cord. In one embodiment, the pump is a low voltage DC pump and the transformer is plugged into the wall and the cord carriers only low voltage DC. In another embodiment, the pump is powered by batteries.

In one embodiment, the pet whirlpool bowl has an air valve 40. The air valve 40 can be opened and allows air to be infused into the water. This freshens the water.

FIG. 4 is a front view of a water inlet 16 in accordance with one embodiment of the invention. The water inlet 16 may have a grate structure 42. The grate structure 42 is designed so that the openings 44 have a portion above the waterline 46 and a portion below the waterline 46. The purpose of this is that the grate 42 then traps hair and other debris floating on the surface of the water. If the opening 44 are completely under water then the hair is never trapped by the inlet 16. Other shapes of inlets could also be used and provide the same effect.

Thus there has been described a whirlpool bowl that keeps the water fresh, is inexpensive to build, easy to wash, does not spill on the floor, and is quiet

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A pet drinking bowl designed to keep water fresh, comprising:
a first housing section containing a drinking bowl and a pump section;
a second housing section covering the pump section;
an inlet between the bowl section and the pump section;
an outlet between the bowl section and the pump section;
a filter adjacent to the inlet; and
a pump having an exit connected to the outlet.

2. The pet drinking bowl of claim 1, wherein the first housing section is dishwasher safe.

3. The pet drinking bowl of claim 1, wherein the pump is a submersible pump.

4. The pet drinking bowl of claim 1, wherein the drinking bowl is circular.

5. The pet drinking bowl of claim 4, wherein the outlet is along an edge of the drinking bowl.

6. The pet drinking bowl of claim 1, further including a gravity feed water reservoir having a passageway into the pump section.

7. The pet drinking bowl of claim 1, wherein the second housing section snap fits onto the first housing section.

8. A pet drinking bowl for keeping water fresh, comprising:
a housing having a base and a top section, the base having a bowl formed therein and the top section covering a portion of the base and forming a pump section;
a first passageway between the bowl and the pump section;
a second passageway between the bowl and the pump section; and
a pump pulling water in through the first passageway and pushing water out of the second passageway.

9. The pet drinking bowl of claim 8, further including a filter adjacent to the first passageway.

10. The pet drinking bowl of claim 9, wherein the filter is a charcoal activated filter.

11. The pet drinking bowl of claim 8, further including a gravity feed reservoir having a channel into the pump section.

12. The pet drinking bowl of claim 8, wherein the base is detachably connected to the top section.

13. The pet drinking bowl of claim 12, wherein the base is made of a dishwasher safe material.

14. The pet drinking bowl of claim 8, wherein the second passageway is along an edge of the pet bowl.

15. A pet bowl for keeping water fresh comprising:
a bowl having a generally circular shape;
a pump section adjacent to the bowl and having an inlet to the bowl and an outlet from the bowl, wherein the inlet is formed along a wall of the bowl; and
a submersible pump in the pump section having a pump outlet attached to the inlet.

16. The pet bowl of claim 15, wherein the bowl and a lower part of the pump section are formed in a base of a housing.

17. The pet bowl of claim 16, further including a cover forming an upper part of the pump section.

18. The pet bowl of claim 17, further including a gravity feed water reservoir having a conduit into the pump section.

19. The pet bowl of claim 18, further including a filter adjacent the submersible pump.

20. The pet bowl of claim 15, wherein the inlet has a portion above a waterline.
